(19) United States
(12) Patent Application Publication
(10) Pub. No.: US 2012/0194436 A1
(43) Pub. Date: Aug. 2, 2012

(54) HANDHELD BED CONTROLLER PENDANT WITH LIQUID CRYSTAL DISPLAY

(76) Inventors: Mahesh Kumar Thodupunuri, Batesville, IN (US); Douglas A. Seim, Okeana, OH (US)

(21) Appl. No.: 13/015,917

(22) Filed: Jan. 28, 2011

(51) Int. Cl. G09G 5/00

(52) U.S. Cl. 345/168

(57) ABSTRACT

A pendant controller for a patient bed includes a housing sized to be held in a user's hand and a liquid crystal display carried by the housing and viewable by the user. The pendant controller has a set of manual buttons carried by the housing adjacent the LCD. The set of manual buttons is arranged in a row and the buttons are n in number, with n being an integer greater than 1. The pendant controller further includes control circuitry situated in the housing and configured to drive the LCD to display a table that is m columns wide, with m being equal to n. The table contains indicia with each indicia corresponding to a function associated with a respective one of the manual buttons.

### BACKGROUND

The present disclosure relates to handheld controllers for patient beds such as beds found in hospitals, nursing homes, and other healthcare facilities. More particularly, the present disclosure relates to handheld bed controller pendants having display screens.

Many patient beds have various systems and functions that are controlled by user input devices. Such user input devices include, for example, buttons of a control panel included as part of a siderail or footboard of the bed. Some patient beds also have hand held controller pendants with user inputs such as buttons. Some of the more sophisticated and expensive patient beds have display screens that are attached to one or more of the siderails or to the footboard. In some instances, the displays screens are touch screens that, themselves, serve as user input devices and, in other instances, the display screens provide information regarding the functions that are controlled by an adjacent set of manual buttons. See U.S. Pat. Nos. 5,732,423 and 5,715,548 and see U.S. Patent Application Publication Nos. 2008/0235872 A1 and 2008/0172789 A1, each of which show examples of display screens on a siderail or footboard of a patient bed. Some hand held controller pendants also have display screens. See, for example, U.S. Pat. Nos. 7,010,369; 6,560,492; 6,396,224; 6351,678 and 6,008,598 for examples of such hand held controller pendants.

### SUMMARY

A pendant controller for a patient bed has one or more of the features recited in the appended claims and/or the following features which, alone or in any combination, may comprise patentable subject matter:

A pendant controller for a patient bed may include a housing sized to be held in a user's hand and a liquid crystal display carried by the housing and viewable by the user. The pendant controller may also have a set of manual buttons carried by the housing adjacent the LCD. The set of manual buttons may be arranged in a row and may be n in number, with n being an integer greater than 1. The pendant controller may further include control circuitry situated in the housing and configured to drive the LCD to display a table that is m columns wide, with m being equal to n. The table may contain indicia with each indicia corresponding to a function associated with a respective one of the manual buttons.

The pendant controller may further comprise an electrical cable coupled to the housing and extending from the housing to the patient bed. In some embodiments, the housing is coupleable to a siderail of the patient bed. For example, the housing may snap into an opening in the siderail or may have a hook, bracket, or similar structure that permits the pendant controller to be hung on the siderail of the patient bed.

In some embodiments, an angle at which a head section of the patient bed is inclined may be displayed on the LCD when the LCD is in a default condition. The angle of inclination of the head section may be with respect to a frame of the patient bed, such as an upper frame or a base frame, or may be with respect to horizontal.

According to some contemplated embodiments, n and m may be at least equal to four such that the set of manual buttons includes a first button, a second button, a third button and a fourth button. In such embodiments, the control circuitry may be configured such that pressing the second button results in the table changing from a home table setting to a scale table setting, pressing the third button results in the table changing from the home table setting to a patient position monitor table setting, and pressing the fourth button results in the table changing from the home table setting to a surface table setting.

The scale table setting may include a home indicia adjacent the first button, a weigh indicia adjacent the second button, a calibration indicia adjacent the third button, and a history indicia adjacent the fourth button. The control circuitry may be configured such that, when the scale table setting is displayed on the LCD, pressing the first button results in the scale table setting changing back to the home table setting, pressing the second button results in a weight of a patient on the patient bed being displayed on the LCD, pressing the third button results in the table changing from the scale table setting to a scale calibration table setting, and pressing the fourth button results in weight history information being displayed on the LCD. For example, the weight history information may includes the date at which the scale system was last calibrated, the time at which the scale system was last calibrated, and the last weight reading that the scale system took.

In some embodiment, the control circuitry may be configured such that, when the scale calibration setting is displayed on the LCD, pressing the first button results in the table changing from the scale calibration setting back to the scale table setting, pressing the second button results in a weight of the patient on the patient bed being displayed on the LCD, pressing the third button results in the table changing to a plus/minus table setting in which one of the manual buttons is used to calibrate a scale system of the patient bed by adding a weight offset and another of the manual buttons is used to calibrate the scale system of the patient bed by subtracting a weight offset, and pressing the fourth button results in the scale system of the bed being zeroed.

The patient position monitor table setting may include a home indicia adjacent the first button, a position indicia adjacent the second button, an exiting indicia adjacent the third button, and an out-of-bed indicia adjacent the fourth button. The control circuitry may be configured such that, when the patient position monitor table setting is displayed on the LCD, pressing the first button results in the patient position monitor table setting changing back to the home table setting; sequential presses of the second button results in a patient position monitoring system of the patient bed being sequentially enabled and disabled in a patient position mode; sequential presses of the third button results in the patient position monitoring system of the patient bed being sequentially enabled and disabled in an exiting mode; and sequential presses of the fourth button results in the patient position monitoring system of the patient bed being sequentially enabled and disabled in an out-of-bed mode.

The surface table setting may include a home indicia adjacent the first button, a select indicia adjacent the second button, an up indicia adjacent the third button, and a down indicia adjacent the fourth button. The control circuitry may be configured such that, when the surface table setting is displayed on the LCD, pressing the first button results in the scale table setting changing back to the home table setting; sequential presses of the second button results in sequential scrolling through a set of mattress zone indicia shown on the LCD to indicate which mattress zone of an air mattress of the patient bed is selected for pressure adjustment; pressing the third button results in a target pressure increase for the mattress zone selected using the second button; and pressing the fourth button results in a target pressure decrease for the mattress zone selected using the second button. The mattress zone indicia may comprise first, second, and third mattress zone indicia, for example.

In some embodiments, a first, second, and third zone pressure numeral may be shown on the LCD adjacent the respective first, second, and third mattress zone indicia. The first, second, and third zone pressure numerals may each represent a percent amount that the respective zone is pressurized toward a maximum pressure.

The control circuitry may be configured such that if the scale table setting, patient position monitor table setting, or surface table setting is shown on the LCD for a threshold amount of time without any of the first, second, third, or fourth buttons being pressed, the home table setting will be displayed on the table. In some embodiments, the threshold amount of time is about five minutes.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the following figures, in which:

FIG. 1 is a diagrammatic view of a handheld bed controller pendant coupled to a bed frame of a patient bed by an electrical cord and, as shown in phantom, the pendant controller having a housing that is coupleable to a siderail of the patient bed;

FIG. 2 is a block diagram of the circuitry of the pendant controller showing a set of RAFI switches communicating with microcontroller and the microcontroller communicating with a liquid crystal display (LCD) via a 3.3 to 5 Volt (V) Pull-Up block;

FIG. 3 is a front elevation view of the pendant controller of FIG. 1 showing a home or default screen being displayed on the LCD with a table configured in a home table setting, with first, second, third, and fourth buttons (from left to right) beneath the LCD with each button being associated with a respective column of the table, and an angle of a head section of a mattress support deck of the bed being displayed on the LCD above the table;

FIG. 4 is a front elevation view, similar to FIG. 3, showing a patient position monitor (PPM) screen that is displayed on the LCD after the second button is pressed while the home screen is displayed to cause the table to change from the home table setting to a PPM table setting and showing information above the table to indicate whether a PPM system of the bed is enabled or disabled and to indicate a selected mode of the PPM system;

FIG. 5 is a front elevation view, similar to FIGS. 3 and 4, showing a scale screen that is displayed on the LCD after the third button is pressed to cause the table to change from the home table setting to a scale table setting and showing a patient weight displayed above the table in response to the second button being pressed after the table has switched to the scale table setting;

FIG. 6 is a front elevation view, similar to FIGS. 3-5, showing a scale calibration screen that is displayed on the LCD after the third button is pressed to cause the table to change from the scale table setting to a scale calibration setting; and

FIG. 7 is a front elevation view, similar to FIGS. 3-6, showing a surface screen that is displayed on the LCD after the fourth button is pressed to cause the table to change from the home table setting to a surface table setting.

### DETAILED DESCRIPTION

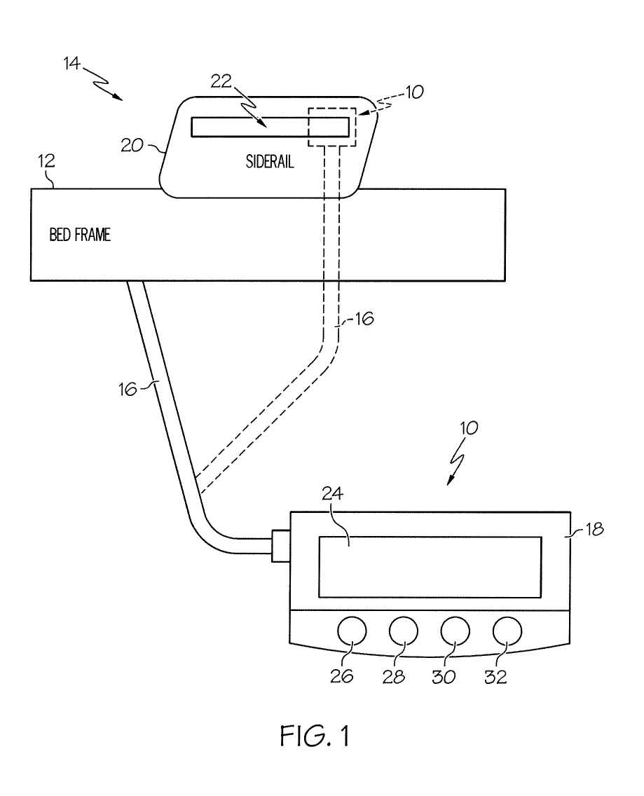

As shown diagrammatically in FIG. 1, a handheld bed controller pendant 10 is coupled to a bed frame 12 of a patient bed 14 by an electrical cord 16. The electrical cord 16 is flexible (as indicated by the dotted lines in FIG. 1) and the pendant controller 10 has a housing 18 that is coupleable to a siderail 20 of the patient bed 14. In some embodiments, housing 18 is coupled to siderail 20 via a coupler, such as a hook, bracket, or strap that extends from the back of housing 18. In other embodiments, housing 18 includes a portion that is shaped for receipt in an opening or slot 22 provided in siderail 20. See, for example, U.S. Pat. No. 6,658,680 which is hereby incorporated by reference herein and which shows an example of a controller pendant that is attachable to a bed siderail in this manner. As is the case with the controller pendant shown in U.S. Pat. No. 6,658,680, in some embodiments, illustrative controller pendant 10 includes a spring loaded pivotable latch that is coupled to housing 18 and that helps to retain pendant 10 in slot 22 of siderail 20. In other embodiments, the latch is omitted such that the housing 18 of controller pendant 10 is sized and shaped so as to have a snap fit within opening 22 of siderail 20. When a caregiver wishes to use pendant 10, the caregiver typically detaches pendant 10 from siderail 20 and holds the pendant 10 in his or her hand during use. This is not to say that controller pendant 10 could not be used while still attached to siderail 20.

Bed 14 is depicted generically in FIG. 1. That is, only a portion of bed 14 is illustrated diagrammatically in FIG. 1. This is because it is contemplated by this disclosure that controller pendant 10 can be used with a variety of different bed types, if desired. In some embodiments, bed 14 is a hospital bed that has an upper frame movable relative to a base frame by an elevation mechanism and that has a mattress support deck with pivotable deck sections supported by the upper frame. Such hospital beds typically also have casters that support the base frame above an underlying floor. Furthermore, while FIG. 1 diagrammatically shows bed 14 having a single siderail 20, it should be understood that multiple barrier elements, such as siderails, a headboard, and a footboard are oftentimes included as part of hospital beds and such is contemplated by this disclosure. Examples of the types of hospital beds for which controller pendant 10 may be suitable include those shown and described in U.S. Pat. Nos. 5,715,548 (relating to features of Hill-Rom's TotalCare® bed), 6,208,250 (relating to features of Hill-Rom's Advanta™ bed), and 7,296,312 (relating to features of Hill-Rom's VersaCare® bed), each of which is hereby incorporated by reference herein. Each of these beds include bed control circuitry that communicates bidirectionally with the circuitry of controller pendant 10 via conductors provided within electrical cable 16.

According to this disclosure, controller pendant 10 includes a liquid crystal display (LCD) screen 24 (sometimes referred to herein as just LCD 24) and first, second, third, and fourth user input buttons 26, 28, 30, 32 adjacent LCD screen 24 for navigating through various screens and for controlling certain functions of bed 14. It is within the scope of this disclosure for more than four or less than four user input buttons to be provided on pendant 10 in other embodiments. The basic idea, however, is to have a fairly low cost controller pendant 10 for controlling functions of bed 14, but that includes some of the benefits of more sophisticated hospital beds that have more expensive types of display screens mounted to their siderails, for example. In some embodiments, LCD screen 24 is a monochromatic LCD screen rather than a more expensive color LCD screen. An example of a low cost, suitable LCD screen is a Model No. DGF-24064S2FBLW-H device available from Data International Co. Ltd. of Taipei Hsien, Taiwan. This particular LCD screen has a 240 by 64 pixel array. Also, in some embodiments, user input buttons 26, 28, 30, 32 comprise membrane switches and, in other embodiments, user input buttons 26, 28, 30, 32 comprise RAFI switches which are available from RAFI GB Limited of Redhill, Surrey, Great Britain.

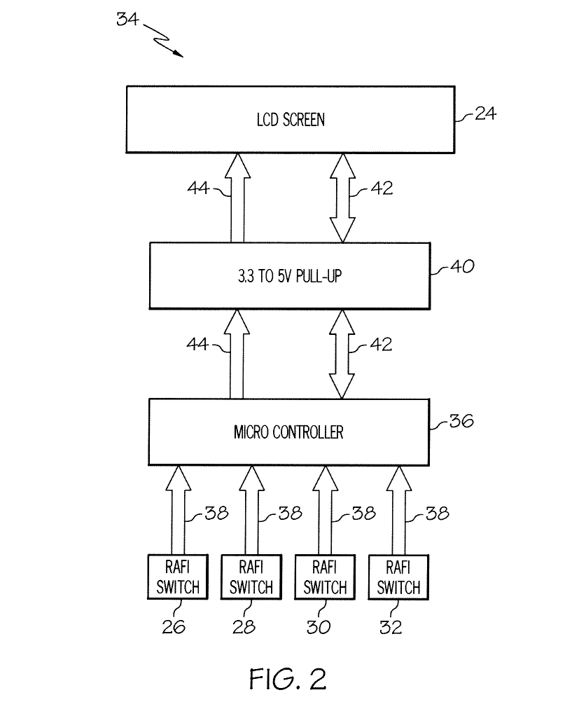

Referring now to the block diagram of FIG. 2, the illustrative embodiment of controller pendant 10 has circuitry 34 including the four RAFI switches 26, 28, 30, 32, each of which communicate with a microcontroller 36 via respective parallel 1-1 communication interfaces 38. Interfaces 38 interconnect switches 26, 28, 30, 32 to input/output (I/O) ports of microcontroller 36. Microcontroller 36 communicates with LCD screen 24 via a 3.3 to 5 Volt (V) Pull-Up block 40. Pull-Up block 40 includes level shifter integrated circuits (IC's) to change voltages of all of a set of I/O data bus lines 42 from 3.3 V to 5 V because LCD display 24 uses 5 V logic levels. A set of input controls 44 between microcontroller 44 also are communicated to LCD display 24 via Pull-Up block 40. The Pull-Up block 40 is also used for direction control of the ports of microcontroller 36. In some embodiments, microcontroller 36 is a Model No. TMS470 microcontroller available from Texas Instruments of Dallas, Tex. In the illustrative embodiment, all of circuitry 34 is carried by or contained within housing 18 of controller pendant 10.

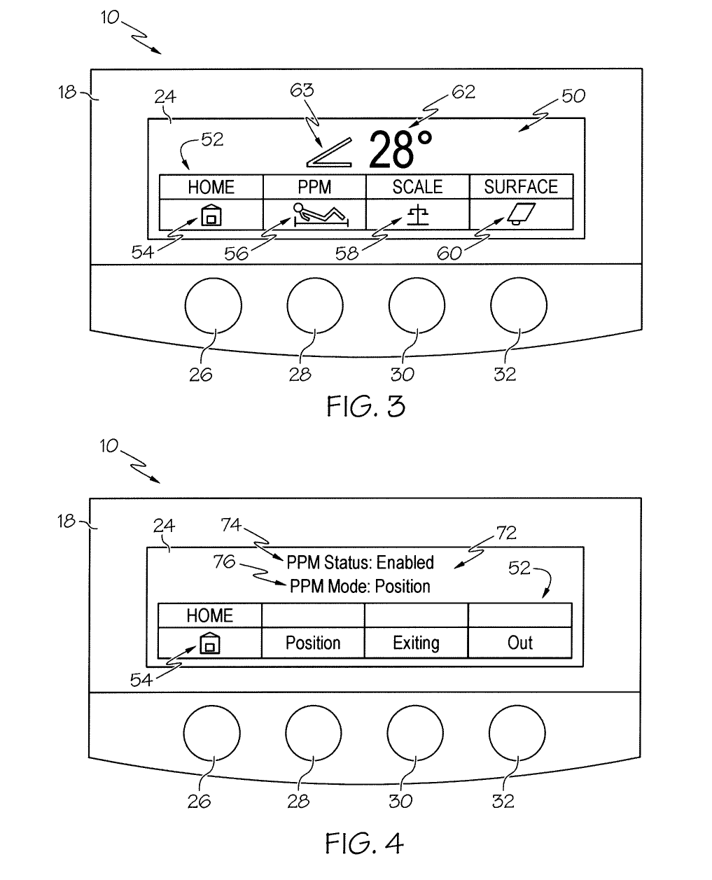

In the illustrative embodiment, LCD display 24 is coupled to two input voltage power levels (not shown). One is 8 V for powering up the pixels on the LCD display 24 and the other is 4 V for a backlight light emitting diode (LED) (not shown). The 8 V level controls the contrast of the pixels. Also, in the illustrative embodiment, LCD display 24 includes its own memory in which the display software and parameters are stored. Microcontroller 36 is programmed with display driver software which is written so as to generate the commands for the graphics, such as circles, alphanumeric data, rectangles, bed-related symbols, and so forth, which are to be displayed on LCD display 24. Thus, the caregiver uses buttons 26, 28, 30, 32 to navigate through various screens that are shown on LCD display 24 and to control various bed functions as will now be described in connection with FIGS. 3-7.

A home or default screen 50, an example of which is shown in FIG. 3, is displayed on the LCD 24 under default conditions such as upon power up or after other screens have timed out or after the user has specifically navigated to the home screen 50. In some embodiments, each of the other screens shown in FIGS. 4-7 and discussed below time out back to home screen 50 after about five minutes of inactivity on the respective screen. Other time out periods that are more or less than five minutes are within the scope of this disclosure. Home screen 50 includes a table 52 having two rows and four columns. The top row includes a text explanation of a corresponding icon or graphic found the bottom row. Each of the columns is generally aligned with an associated button 26, 28, 30, 32. Pressing one of buttons 26, 28, 30, 32 results in the user navigating to other screens associated with the functions depicted by the graphics and text shown in table 52. In the illustrative example, a home table setting of table 52 includes the word “HOME” with a home icon 54 in the first column, the text “PPM” with a patient icon 56 in the second column, the text “SCALE” with a scale icon 58 in the third column, and the word “SURFACE” with a mattress icon 60 in the fourth column. Furthermore, an angle 62 of a head section of the mattress support deck of bed 14 is displayed on LCD 24 above table 52 along with an angle icon 63 just to the left of the angle 62. In the illustrative example, angle 62 is twenty eight degrees.

Based on the foregoing, it will be appreciated that, according to this disclosure, controller pendant 10 has a set of manual buttons that are arranged in a row and that are n in number and that the control circuitry 34 situated in housing 18 is configured to drive the LCD 24 to display a table that is m columns wide, with m being equal to n. Furthermore, the table contains indicia with each indicia corresponding to a function associated with a respective one of the manual buttons. The indicia may include alphanumeric text or a graphical icon or both according to this disclosure.

If button 28 is pressed while the user is viewing the home screen of FIG. 3, a patient position monitor (PPM) screen 72 is displayed on the LCD 24 as shown, for example, in FIG. 4. In the illustrative example, a PPM table setting of table 52 includes the word “HOME” with home icon 54 in the first column, the text “Position” in the bottom row of the second column (the top row of the second column is blank), the text “Exiting” in the bottom row of the third column (the top row of the third column is blank), and the text “Out” in the bottom row of the fourth column (the top row of the fourth column is blank). The words Position, Exiting, and Out, correspond to three different PPM modes in which a PPM system of bed 14 may be enabled. Details of these three types of PPM modes are provided in U.S. Pat. No. 7,253,366 which is already incorporated by reference herein. In general, the position mode is the most sensitive mode and an alarm is generated if the patient moves by a small amount on bed 14, such as by sitting up in bed for example. The exiting mode is less sensitive and an alarm is generated if the patient moves toward exiting the bed by a modest amount, such as by moving toward a side or end of the bed. The out of bed mode is the least sensitive and an alarm is generated if the patient starts to actually get out of the bed.

Above table 52 of PPM screen are a first text field 74 and a second text field 76. The first text field 74 indicates whether the PPM system is enabled or disabled and the second text field 76 indicates the mode that has been selected using one of buttons 28, 30, 32. In the illustrative example of FIG. 4, field 74 includes the text “PPM Status: Enabled” and field 76 includes the text “PPM Mode: Position.” Thus, in the FIG. 4 example, the PPM system of bed 14 is in enabled in the position mode. If the user wishes to switch to another PPM mode, then the user presses button 30 to switch to the exiting mode and the user presses button 32 to switch to the out of bed mode. If the user wishes to disable the PPM system, the user presses button 28 again because that is the button corresponding to the mode in which the PPM system is currently enabled. If the system were enabled in another mode, then the user would press the button (i.e., either button 30 or button 32) corresponding to that mode to disable the PPM system. The text in fields 74, 76 changes corresponding to the user's use of buttons 28, 30, 32 while viewing the PPM screen 72. If the user presses button 26 while viewing the PPM screen 72, LCD 24 returns to the home screen 50.

While viewing the home screen 50, if the user presses third button 30 which is beneath the SCALE column of table 52, the home screen 50 is replaced by a scale screen 64 as shown, for example, in FIG. 4. In the illustrative example, a scale table setting of table 52 includes the word “HOME” with home icon 54 in the first column, the text “Weigh” in the bottom row of the second column (the top row of the second column is blank), the text “CAL” in the bottom row of the third column (the top row of the third column is blank), and the text “History” with a clock icon 66 in the fourth column. A patient weight field 68 is provided above table 52 on the scale screen 64.

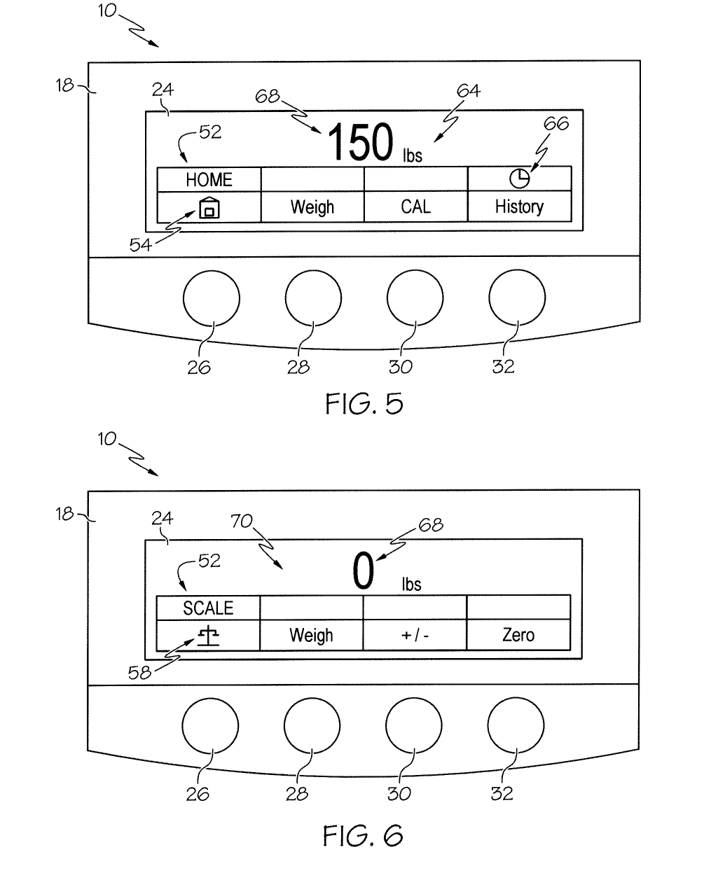

If the user presses button 26 while viewing the scale screen 64, LCD display will return back to the home screen 50. When the user first navigates to the scale screen 64, the patient weight field is blank or reads zero pounds (lbs) or some similar type of information is provided in field 68 to indicate that a weight reading has not yet been taken. If the user presses button 28 while viewing the scale screen 64, a patient weight reading appears in field 68. In the illustrative example of FIG. 5, the weight reading “150 lbs” appears in field 68. The weight reading is provided to the circuitry 34 of controller pendant 10 by the portion of the circuitry of bed 14 associated with a weigh scale system of bed 14. See U.S. Pat. Nos. 5,715,548; 6,208,250; and 7,296,312 which are already incorporated by reference herein and which show and describe examples of weigh scale systems included in hospital beds. See also U.S. Pat. No. 7,253,366 which shows another example of a weigh scale system of a hospital beds and which is hereby incorporated by reference herein.

If the user presses button 30 while viewing scale screen 64, a scale calibration screen 70 is displayed on the LCD 24 and table 52 changes from the scale table setting to a scale calibration setting as shown, for example, in FIG. 6. In the illustrative example, the scale calibration setting of table 52 includes the word “SCALE” with scale icon 58 in the first column, the text “Weigh” in the bottom row of the second column (the top row of the second column is blank), the text “+/−” in the bottom row of the third column (the top row of the third column is blank), and the text “Zero” in the bottom row of the fourth column (the top row of the third column is blank). The patient weight field 68 above table 52 initially displays 0 lbs when the user first navigates to the scale calibration screen 70.

If the user presses button 26 while viewing the scale calibration screen, the scale screen 64 of FIG. 4 is shown on LCD 24. In the illustrative example, button 28 is inactive and, therefore, not usable to take a patient weight reading while the user is viewing the scale calibration screen 70. In some embodiments, a certain number of sequential presses of button 30 while viewing the scale calibration screen will cause the scale system to be calibrated up or calibrated down in 1 lb increments. For example, according to one programmatic scheme, a quick succession of three presses of button 30 results in a calibration of +1 lb and a quick succession of four presses of button 30 results in a calibration of −0.1 lb. The user can perform a number of three press sequences or four press sequences to continue to increase or decrease the calibration number as desired. Programmatic schemes in which different numbers of button presses (i.e., other than three presses and/or four presses) are within the scope of this disclosure. The calibration numbers appearing in field 68 on screen 64 are basically the amount of weight added to or subtracted from the base weight reading of the scale system. Further programmatic calibration schemes are also within the scope of this disclosure. For example, in some embodiments, pressing button 30 while viewing scale calibration screen 64 results in another screen (not shown) appearing on LCD 24 with one of buttons 26, 28, 30, 32 being dedicated for increasing the calibration number and another of buttons 26, 28, 30, 32 being dedicated for decreasing the calibration number. If the user presses button 32 while viewing the scale calibration screen 70, the scale calibration number in field 68 returns to zero. Button 32, therefore, can be used to establish a tare weight for the scale system of bed 14.

If button 32 is pressed while the user is viewing the scale screen 64 of FIG. 5, then history information (not shown) appears on LCD 24. In some embodiments, the history information may include the last calibration date, the last calibration time, and the last weight reading that was taken. While viewing the history information, the use is able to press the button 26, 28, 30, 32 associated with a scale icon to return back to the scale screen 64.

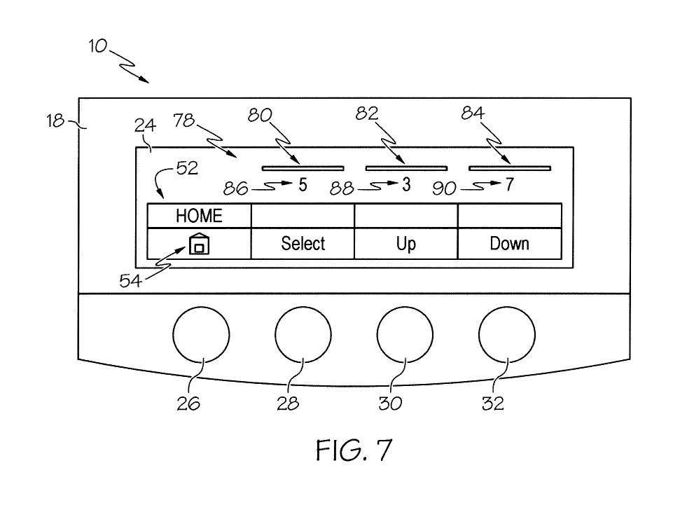

If button 32 is pressed while the user is viewing the home screen of FIG. 3, a surface screen 72 is displayed on the LCD 24 as shown, for example, in FIG. 7. In the illustrative example, a surface table setting of table 52 includes the word “HOME” with home icon 54 in the first column, the text “Select” in the bottom row of the second column (the top row of the second column is blank), the text “Up” in the bottom row of the third column (the top row of the third column is blank), and the text “Down” in the bottom row of the fourth column (the top row of the fourth column is blank).

Above table 52 of the surface screen 72 is first, second and third selection bars or icons 80, 82, 84 and first, second and third inflation fields 86, 88, 90. The selection bars 80, 82, 84 correspond to the zones of an air mattress of bed 14 and the fields 86, 88, 90 each have a number that indicates, in some respect, the inflation level or amount of the corresponding zone. Thus, in the illustrative example, the air mattress of bed 14 has three zones for which inflation (e.g., firmness or softness) can be controlled using controller pendant 10. In other embodiments, the air mattress of bed 14 has a different number of zones, either more or less than three, the inflation/deflation of which is commanded by pendant 10, and in such embodiment, a corresponding number of bars and inflation fields are shown on LCD 24. It should be understood that bed 14 includes a pneumatic system with an air source, such as a pump, compressor or blower, and associated valves, tubing, circuitry, sensors, etc. that cooperate to inflate and deflate the various zones of the air mattress.

While viewing surface screen 78 on LCD 24, the user presses button 28 sequentially to cycle through the selection of the zones of the air mattress. As the user cycles though the zones, the respective bar or icon 80, 82, 84 which is selected becomes highlighted, such as by being filled in or by blinking, for example. In some embodiments, one of the sequential button presses of button 28 corresponds to none of the zones being selected. In such embodiments, therefore, the sequence of selection is along the lines of first zone, second zone, third zone, no zones, first zone, second zone, and so forth.

After the user has selected the desired zone on screen 78 using button 28, the user then presses button 30 if the user wishes to command the pneumatic system of bed 14 to further inflate the selected zone to make it firmer or the user presses button 32 if the user wishes to command the pneumatic system of bed 14 to deflate the selected zone to make it softer. The number in the inflation field 86, 88, 90 corresponding to the selected zone is adjusted, either up or down, to match the relative amount that the user commands the zone to inflate or deflate. The numbers in fields 86, 88, 90 may be arbitrary numbers, such as in a range between 0 and 10, or 0 and 100, to indicate the relative amount of inflation between empty and full, or the numbers in fields 86, 88, 90 may corresponding to sensed pressures in the corresponding mattress zones. Thus, the numbers in fields 86, 88, 90 may have units of pounds per square inch (psi), millimeters of water (mmH₂O), millimeters of Mercury (mmHg), Pascals, etc.

Although certain illustrative embodiments have been described in detail above, many embodiments, variations and modifications are possible that are still within the scope and spirit of this disclosure as described herein and as defined in the following claims.

1. A pendant controller for a patient bed, the pendant controller comprising
a housing sized to be held in a user's hand,
a liquid crystal display carried by the housing and viewable by the user,
a set of manual buttons carried by the housing adjacent the LCD, the set of manual buttons being arranged in a row and being n in number, wherein n is an integer greater than 1, and
control circuitry situated in the housing and configured to drive the LCD to display a table that is m columns wide, wherein m is equal to n, and the table contains indicia with each indicia corresponding to a function associated with a respective one of the manual buttons.

2. The pendant controller of claim 1, further comprising an electrical cable coupled to the housing and extending from the housing to the patient bed.

3. The pendant controller of claim 1, wherein the housing is coupleable to a siderail of the patient bed.

4. The pendant controller of claim 1, wherein an angle at which a head section of the patient bed is inclined is displayed on the LCD when the LCD is in a default condition.

5. The pendant controller of claim 1, wherein n and m are at least equal to four such that the set of manual buttons includes a first button, a second button, a third button and a fourth button.

6. The pendant controller of claim 5, wherein the control circuitry is configured such that pressing the second button results in the table changing from a home table setting to a scale table setting, the control circuitry is configured such that pressing the third button results in the table changing from the home table setting to a patient position monitor table setting, and the control circuitry is configured such that pressing the fourth button results in the table changing from the home table setting to a surface table setting.

7. The pendant controller of claim 6, wherein the scale table setting includes a home indicia adjacent the first button, a weigh indicia adjacent the second button, a calibration indicia adjacent the third button, and a history indicia adjacent the fourth button.

8. The pendant controller of claim 7, wherein the control circuitry is configured such that, when the scale table setting is displayed on the LCD, pressing the first button results in the scale table setting changing back to the home table setting, pressing the second button results in a weight of a patient on the patient bed being displayed on the LCD, pressing the third button results in the table changing from the scale table setting to a scale calibration table setting, and pressing the fourth button results in weight history information being displayed on the LCD.

9. The pendant controller of claim 8, wherein the weight history information includes the date at which the scale system was last calibrated, the time at which the scale system was last calibrated, and the last weight reading that the scale system took.

10. The pendant controller of claim 8, wherein the control circuitry is configured such that, when the scale calibration setting is displayed on the LCD, pressing the first button results in the table changing from the scale calibration setting back to the scale table setting, pressing the second button results in a weight of the patient on the patient bed being displayed on the LCD, pressing the third button results in the table changing to a plus/minus table setting in which one of the manual buttons is used to calibrate a scale system of the patient bed by adding a weight offset and another of the manual buttons is used to calibrate the scale system of the patient bed by subtracting a weight offset, and pressing the fourth button results in the scale system of the bed being zeroed.

11. The pendant controller of claim 6, wherein the patient position monitor table setting includes a home indicia adjacent the first button, a position indicia adjacent the second button, an exiting indicia adjacent the third button, and an out-of-bed indicia adjacent the fourth button.

12. The pendant controller of claim 11, wherein the control circuitry is configured such that, when the patient position monitor table setting is displayed on the LCD, pressing the first button results in the patient position monitor table setting changing back to the home table setting; sequential presses of the second button results in a patient position monitoring system of the patient bed being sequentially enabled and disabled in a patient position mode; sequential presses of the third button results in the patient position monitoring system of the patient bed being sequentially enabled and disabled in an exiting mode; and sequential presses of the fourth button results in the patient position monitoring system of the patient bed being sequentially enabled and disabled in an out-of-bed mode.

13. The pendant controller of claim 6, wherein the surface table setting includes a home indicia adjacent the first button, a select indicia adjacent the second button, an up indicia adjacent the third button, and a down indicia adjacent the fourth button.

14. The pendant controller of claim 13, wherein the control circuitry is configured such that, when the surface table setting is displayed on the LCD, pressing the first button results in the scale table setting changing back to the home table setting; sequential presses of the second button results in sequential scrolling through a set of mattress zone indicia shown on the LCD to indicate which mattress zone of an air mattress of the patient bed is selected for pressure adjustment; pressing the third button results in a target pressure increase for the mattress zone selected using the second button; and pressing the fourth button results in a target pressure decrease for the mattress zone selected using the second button.

15. The pendant controller of claim 14, wherein the mattress zone indicia comprise first, second, and third mattress zone indicia.

16. The pendant controller of claim 15, wherein a first, second, and third zone pressure numeral is shown on the LCD adjacent the respective first, second, and third mattress zone indicia.

17. The pendant controller of claim 16, wherein the first, second, and third zone pressure numerals each represent a percent amount that the respective zone is pressurized toward a maximum pressure.

18. The pendant controller of claim 6, wherein the control circuitry is configured such that if the scale table setting, patient position monitor table setting or surface table setting is shown on the LCD for a threshold amount of time without any of the first, second, third, or fourth buttons being pressed, the home table setting will be displayed on the table.
